(19) United States
(12) Patent Application Publication
(10) Pub. No.: US 2026/0162666 A1
(43) Pub. Date: Jun. 11, 2026

(54) CAUSAL AUDIO TOKENIZER

(71) Applicant: GDM Holding LLC, Mountain View, CA (US)

(72) Inventors: Bo Li, Fremont, CA (US); Qiujia Li, Mountain View, CA (US); Tara N. Sainath, Jersey City, NJ (US)

(21) Appl. No.: 19/413,969

(22) Filed: Dec. 9, 2025

Related U.S. Application Data
(60) Provisional application No. 63/730,949, filed on Dec. 11, 2024.

(51) Int. Cl. G10L 19/038; G06N 3/0475; G06N 3/08; G10L 15/26; G10L 25/30

(52) U.S. Cl. CPC G10L 19/038; G06N 3/0475; G06N 3/08; G10L 15/26; G10L 25/30

(57) ABSTRACT

Methods, systems, and apparatus, including computer programs encoded on computer storage media, for training an audio tokenizer to perform audio tokenization. One of the methods includes obtaining an audio input; processing the audio input using an audio tokenizer to generate one or more audio tokens; generating a representation of the audio input based on the one or more audio tokens; processing the representation using a reconstruction neural network to generate a predicted reconstruction of the audio input; processing the representation using a transcription neural network to generate an output that specifies a predicted text transcript of the audio input; and training the audio tokenizer on a loss function that includes a first term and a second term.

### CROSS-REFERENCE TO RELATED APPLICATIONS

This application claims priority to U.S. Provisional Application No. 63/730,949, filed on Dec. 11, 2024. The disclosure of the prior application is considered part of and is incorporated by reference in its entirety in the disclosure of this application.

### BACKGROUND

This specification relates to processing audio data using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a training system implemented as computer programs on one or more computers in one or more locations that trains an audio tokenizer to perform audio tokenization.

Audio tokenization refers to converting continuous audio signals into audio tokens. Audio tokenization bridges the gap between continuous audio signals and computational processes. Unlike text or images, which are inherently discrete, audio data exists as a continuous waveform, presenting unique challenges for digital processing and machine learning applications.

The subject matter described in this specification can be implemented in particular embodiments so as to realize one or more of the following advantages.

The specification describes techniques that improve the quality of the audio tokens that can be generated by an audio tokenizer once trained. For example, a training system implementing the described techniques can train the audio tokenizer to generate audio tokens that encode richer semantic and acoustic information than audio tokens that would be generated by another audio tokenizer trained by a conventional training system that generates either acoustic or semantic tokens.

By training the audio tokenizer jointly with one or more additional neural networks, the training system can train the audio tokenizer to generate higher quality audio tokens without causing an excessively large increase in computation resource consumption relative to a conventional training system during the training of the audio tokenizer, because unlike the conventional training system which focuses on training the audio tokenizer on a single task (e.g., either a reconstruction task or a transcript prediction task), the training system need not perform separate backward passes through the audio tokenizer to respectively update the trainable parameters of the audio tokenizer with respect to a reconstruction task and a transcript prediction task.

When processed by an inference system, the higher quality audio tokens that can be generated by the audio tokenizer, in turn, improve the performance of the inference system in any of a range of applications compared to a known system. For example, the inference system can perform audio understanding tasks, question answering tasks, and other audio processing tasks with a higher level of performance, e.g., by generating a more accurate answer to a question posed about an audio input. As another example, the inference system can classify audio inputs with greater accuracy than some known audio classification systems. As another example, the inference system can generate more realistic and natural sounds, e.g., music, than some known audio generation systems.

Advantageously, the audio tokenizer described in this specification can be used to improve the performance of an inference system in streaming audio applications where the audio inputs are audio samples in a live streaming audio that is being received as a stream of audio samples as they become available. In streaming audio applications, the audio tokenizer enables up-to-date outputs that characterize the latest audio samples to be continuously generated. That is, the inference system adopting the audio tokenizer and, e.g., a multi-modal neural network, can receive the audio stream and generate outputs that characterize the audio stream in real-time.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system and an example inference system.

FIG. 2 shows an example architecture of the audio tokenizer.

FIG. 3 is a flow diagram of an example process for training an encoder neural network.

FIG. 4 is a flow diagram of another example process for training an encoder neural network.

FIG. 5 is a flow diagram of another example process for training an encoder neural network.

Like reference numbers and designations in the various drawings indicate like elements.

### DETAILED DESCRIPTION

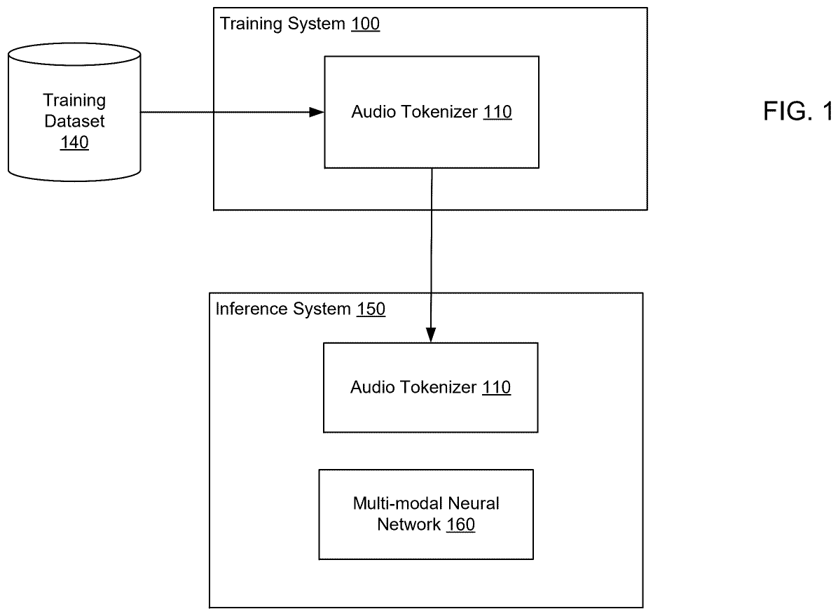

FIG. 1 shows an example training system 100 and an example inference system 150. The training system 100 and the inference system 150 are examples of a system implemented as computer programs on one or more computers in one or more locations, in which the systems, components, and techniques described below can be implemented.

The training system 100 trains an audio tokenizer 110 on a training dataset 140 that includes a plurality of audio inputs for deployment at the inference system 150 to compute inference. Once trained, the inference system 150 can use the audio tokenizer 110 to perform computerized tasks based on received audio inputs.

To perform a computerized task, the audio tokenizer 110 receives an audio input and tokenizes the audio input into audio tokens, i.e., generates one or more audio tokens based on the audio input.

The audio tokenizer 110 can tokenize the audio input by converting the audio input into respective audio tokens using one or more neural networks. Each respective audio token is a discrete audio token (a discrete codeword) selected from a codebook included in or associated with the audio tokenizer 110 that includes a discrete set of audio tokens.

Put another way, the total number of audio tokens (codewords) in the codebook is a finite, fixed number that is less than the largest number of distinct audio tokens that are representable in a given numerical format that a computer system can use, and thus each audio token generated by the audio tokenizer is one of the finite number of audio tokens included in the codebook.

The audio tokenizer 110 can operate on audio data in any of a variety of different representations (spaces).

In some implementations, the audio tokenizer 110 operates in a waveform space, i.e., the audio tokenizer receives audio inputs that are represented as waveform data. A waveform is the continuous, analog representation of an audio. In these implementations, the audio tokenizer 110 processes raw, time-domain audio signals directly.

In some other implementations, the audio tokenizer 110 operates in a spectrogram space, i.e., the audio tokenizer receives audio inputs that are represented as spectrogram data. A spectrogram is a time-frequency domain representation of an audio which visualizes the frequency content of the audio as it changes over time.

In some other implementations, the audio tokenizer 110 operates in a spectrum space, i.e., the audio tokenizer receives audio inputs that are represented as spectrum data. A spectrum is a frequency-domain representation of an audio. In these implementations, the audio tokenizer 110 operates on the magnitude and/or phase information.

During training, the training system 100 trains the audio tokenizer 110 jointly with one or more additional neural networks to improve the quality of the audio tokens that can be generated by the audio tokenizer 110 once trained. Thus, the audio tokens generated by the audio tokenizer 110 can encode richer information than audio tokens generated by another audio tokenizer trained by a conventional training system.

In particular, the training system 100 trains the audio tokens in the codebook such that each audio token captures both semantic features and acoustic features of the audio input. This is in contrast to some conventional systems which, for any audio input, separately generate semantic tokens that are a semantic representation of the audio input and generate acoustic tokens that are an acoustic representation of the audio input.

More specifically, by virtue of the training, each audio token in the codebook can represents semantic content of the audio input and acoustic properties of the audio input.

Examples of semantic content that can be represented by an audio token include linguistic content, phonetics, language syntax, and prosodic features for speech. Examples of semantic content can also include genre, melody, harmony, and rhythmic properties for music.

Acoustic properties capture the details of an audio waveform and allow for high-quality synthesis. Acoustic properties can include, for example, speaker identity. Acoustic properties can also include recording conditions such as level of reverberation, distortion, and background noise.

Once trained, the audio tokenizer 110 can serve as a foundation model for any of a wide range of computerized tasks, including audio processing tasks, audio analysis tasks, audio generation tasks, machine learning tasks, among other tasks.

For example, the inference system 150 can be configured as a speech processing system, and the audio tokenizer 110 can be used by the speech processing system to perform one or more of: speech recognition tasks, which involve converting spoken language into text; speaker diarization tasks, which involve identifying and separating speakers in a conversation; emotion recognition tasks, which involve detecting emotional states from speech; text-to-speech tasks, which involve generating realistic speech from text; or speech-to-speech translation tasks, which involve translating speech between languages while preserving voice characteristics; and so on.

As another example, the inference system 150 can be configured as an audio generation system, and the audio tokenizer can be used by the audio generation system in addition to one or more other components, e.g., a synthesizer, to perform one or more of: music generation tasks, which involve creating music compositions; sound effect synthesis tasks, which involve producing realistic sound effects for various applications from text and/or audio; audio enhancement and restoration tasks, e.g., noise reduction and dereverberation tasks, which involve improving audio quality by removing unwanted noise and reverb; audio upscaling tasks, which involve enhancing the quality of low-fidelity audio; audio classification and analysis tasks, e.g., genre classification tasks, which involve identifying music genres automatically; environmental sound recognition tasks, which involve classifying various environmental sounds; assistive tasks, e.g., real-time transcription tasks, which involve providing text transcriptions for the hearing impaired; and so on.

Some of these computerized tasks, e.g., multi-modal machine learning tasks, require the inference system 150 to process, i.e., receive, generate, or both, multi-modal data, by using a multi-modal neural network 160 together with the audio tokenizer 110. The multi-modal data includes audio data and data in at least one other modality, e.g., text data, image data, or video data.

Examples of such multi-modal neural networks include those described in Comanici, Gheorghe, et al. Gemini 2.5: Pushing the frontier with advanced reasoning, multimodality, long context, and next generation agentic capabilities. arXiv preprint arXiv: 2507.06261 (2025), and Driess, Danny, et al. Palm-e: An embodied multimodal language model. (2023).

As one example the multi-modal data may comprise audio-visual data, comprising a combination of pixels of an image or of video and audio data representing values of a digitized audio waveform. As another example the multi-modal data may comprise a combination of i) text data representing text in a natural language and ii) audio data representing values of an audio waveform. Optionally, but not necessarily, the different types of data may represent the same or overlapping objects using the different modalities (types), and when processing multi-modal data the data may be mapped into a common embedding space.

As a particular example, the task is a multi-modal processing task that requires processing both audio and text inputs, where the audio inputs are processed by the audio tokenizer 110 prior to being processed by the multi-modal neural network 160 which also processes the text inputs or data derived from the text inputs. That is, the output to be generated by the multi-modal neural network 160 for the task depends on the audio tokens generated by the audio tokenizer 110 from the audio inputs (such as spoken language).

Examples of such tasks include speech translation (e.g., translating a spoken sentence into a target language's text), spoken question answering (retrieving text answers from a knowledge base based on a spoken query), and audio-based text retrieval (finding relevant documents using a spoken prompt).

As another particular example, the task is a multi-modal processing task that requires processing both audio and image inputs, where the audio inputs are processed by the audio tokenizer 110 prior to being processed by the multi-modal neural network 160 which also processes the image inputs or data derived from the image inputs. That is, the output to be generated by the multi-modal neural network 160 for the task depends on the audio tokens generated by the audio tokenizer 110 from the audio inputs (such as a sound).

Examples of such tasks include audio-visual event recognition (identifying the sound source in an image, such as detecting an explosion sound only if the image shows fire), sound localization (identifying the location in an image where a specific sound is originating), cross-modal retrieval (searching for images based on a sound input, or vice versa), and audio-guided image generation (generating an image of a scene that matches a particular environmental sound).

In some cases, the accuracy or quality of a computerized task may be increased when the task is applied to multi-modal data that combines audio data with another type of data (such as video, image, or text). For example, detection or classification of an object, event, or utterance may be improved when data of multiple different types (modalities) is processed. As another example, the quality (e.g., fidelity, naturalness, or intelligibility) of generated audio (such as speech synthesis or sound effects) or a generated video/image may be improved when data of multiple different types (modalities) is processed, such as conditioning the video or text generation on a corresponding audio track.

As another example, the inference system 150 can be configured as a live audio processing system, where the audio input includes audio samples in a live streaming audio that is being received as a stream of audio samples as they become available, and the audio tokenizer 110 can be used by the speech processing system to perform one or more of: transcription tasks, where the inference system 150 outputs a stream of text tokens that form a continuous, real-time transcript of the spoken audio; audio scene classification tasks, where the inference system 150 outputs labels that categorize speeches and/or non-speech sound events in an acoustic environment into a predetermined set of scene classifications in real-time; and so on.

In some implementations, a single inference system can perform all these different types of tasks and possibly other tasks using the same audio tokenizer 110.

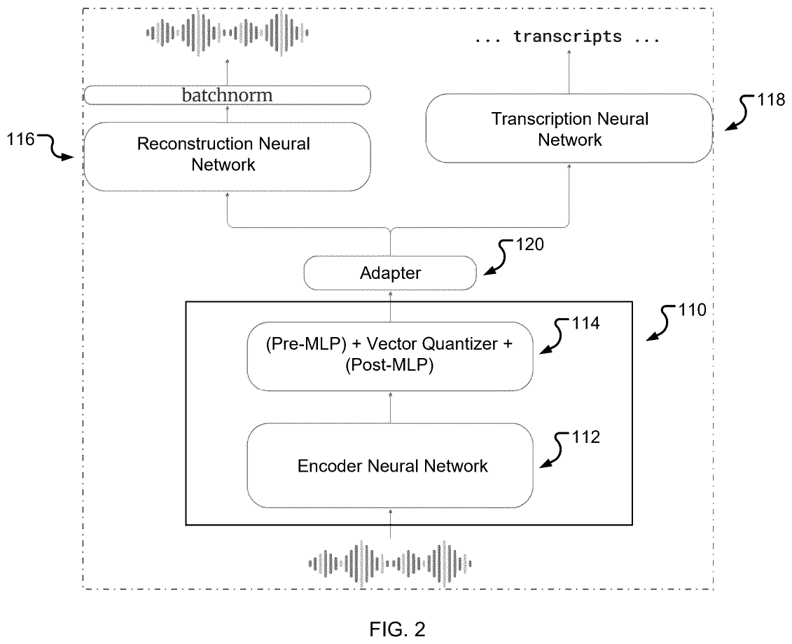

FIG. 2 shows an example architecture of the audio tokenizer 110 that can be trained by a training system, e.g., the training system 100 of FIG. 1, on a training dataset 140 that includes a plurality of audio inputs, and that can be used by an inference system, e.g., the inference system 150 of FIG. 1, to tokenize an audio input into audio tokens.

As shown in FIG. 2, the audio tokenizer 110 includes one or more neural networks. The one or more neural networks include an encoder neural network 112 and a vector quantizer 114.

The encoder neural network 112 is configured to process an audio input to generate a set of embeddings.

An “embedding” as used in this specification is a sequence of one or more vectors of numeric values, e.g., floating point values or other values, each vector having a pre-determined dimensionality. A space of possible vectors having the pre-determined dimensionality is referred to as an “embedding space.”

The encoder neural network 112 can have any of a variety of architectures that enable it to map an audio input to a set of embeddings. For example, the encoder neural network 112 can have a Transformer architecture that includes one or more attention layers, a convolutional architecture that includes one or more convolutional layers, a recurrent architecture that includes one or more recurrent layers, e.g., Long Short-Term Memory (LSTM) layers, or a hybrid architecture that includes, e.g., both a Transformer architecture and a convolutional architecture, and so on.

In some implementations, the encoder neural network 112 is implemented based on the Conformer architecture described in Gulati, Anmol, et al. Conformer: Convolution-augmented transformer for speech recognition. arXiv preprint arXiv: 2005.08100 (2020). That is, the encoder neural network 112 includes a stack of one or more convolution-augmented attention blocks. Each convolution-augmented attention block includes one or more multi-head self-attention layers and one or more convolution layers, e.g., depthwise convolution layers.

In some of these implementations, the encoder neural network 112 has a modified Conformer architecture that enables the encoder neural network 112 to generate the set of embeddings causally, i.e., based only on the current audio sample and one or more previous audio samples that precede the current audio sample, and not on any subsequent audio samples subsequent to the current audio sample.

For example, each convolution-augmented attention block can be modified to apply a causal masking. Here causal masking refers to, e.g., masking values so that at each time step the convolution-augmented attention block sees only the current audio sample and past audio samples in a sequence of audio samples included in the audio input.

In some of these implementations, the encoder neural network 112 disables positional encoding, e.g., absolute positional encoding, such that each convolution-augmented attention block does not receive additional information about the positions of the audio samples in the audio input.

In some implementations, the encoder neural network 112 can be initialized using a base encoder neural network that has already been pre-trained, e.g., on different training data, different loss functions, and so on. That is, the encoder neural network 112 can start with the same architecture and parameters as (at least some part of) the pre-trained base encoder neural network.

The vector quantizer 114 includes or is associated with a codebook that includes a discrete set of audio tokens. The vector quantizer 114 is configured to map each embedding in the set of embeddings generated by the encoder neural network 112 to a corresponding audio token in the discrete set of audio tokens included in the codebook. The embeddings and the audio tokens may reside in the same embedding space.

In some implementations, the codebook can be initialized using a learned codebook that has already been pre-trained, e.g., as part of the training of another audio tokenizer. That is, the discrete set of audio tokens included in the codebook is initialized to be the same as a set of pre-trained audio tokens included in a predetermined codebook.

For example, the vector quantizer 114 can map an embedding to an audio token that satisfies a similarity criterion, e.g., is most similar, to the embedding according to some similarity measure.

For some similarity measures, e.g., Euclidean distance or other distance measures, the most similar audio token is the one that is closest to the embedding in the embedding space (has the smallest similarity measure with the embedding). For some other similarity measures, e.g., inner product, the most similar audio token is the one that has the largest similarity measure with the embedding.

As part of the training of the audio tokenizer 110, the training system 100 updates the values of at least some of the parameters of the audio tokenizer 110. For example, the training system 100 can update the values of the parameters of the encoder neural network 112. As another example, the training system 100 can update the audio tokens in the codebook.

During training, the training system 100 trains the audio tokenizer 110 jointly with one or more additional neural networks to improve the quality of the audio tokens that can be generated by the audio tokenizer 110 once trained.

The one or more additional neural networks, which are used by the training system 100 during the training of the audio tokenizer 110, may not be needed by the inference system 150 during inference. For example, they need not be deployed together with the audio tokenizer 110 in the inference system 150 when performing the computerized tasks.

The one or more additional neural networks used by the training system 100 include a reconstruction neural network 116 and a transcription neural network 118.

The reconstruction neural network 116 is configured to process a representation of the audio input to generate a predicted reconstruction of the audio input.

The transcription neural network 118 is configured to process a representation of the audio input to generate a predicted text transcript of (an utterance in) the audio input.

The representation of the audio input to be processed by both the reconstruction neural network 116 and the transcription neural network 118 can be generated based on the one or more audio tokens that have been generated by using the audio tokenizer 110 for the audio input.

The reconstruction neural network 116 and the transcription neural network 118 can each have any of a variety of architectures that enable them to perform their respective functionalities. For example, the reconstruction neural network 116 and the transcription neural network 118 can each have a Transformer architecture that includes one or more attention layers, a convolutional architecture that includes one or more convolutional layers, a recurrent architecture that includes one or more recurrent layers, e.g., Long Short-Term Memory (LSTM) layers, or a hybrid architecture that includes, e.g., both a Transformer architecture and a convolutional architecture, and so on.

In some implementations, the reconstruction neural network 116 includes a batch normalization (“batchnorm”) layer. A batch normalization layer is a layer that, during the training of the audio tokenizer 110, receives as input the outputs generated by a preceding layer in the reconstruction neural network 116 for audio inputs in a batch, generates a batch normalization layer output for each of the audio inputs by applying a batch normalization operation, and then outputs the batch normalization layer outputs as the final, predicted reconstructions of the audio inputs.

In some implementations, the reconstruction neural network 116, the transcription neural network 118, or both can be initialized using a base generative neural network that has already been pre-trained, e.g., on different training data, different loss functions, and so on. That is, the reconstruction neural network 116, the transcription neural network 118, or both can start with the same architecture and parameters as (at least some part of) the pre-trained base generative neural network.

For example, the transcription neural network 118 can be initialized using one of the text-only generative neural networks described in Gemini 2.5: Pushing the frontier with advanced reasoning, multimodality, long context, and next generation agentic capabilities. arXiv preprint arXiv: 2507.06261 (2025).

In some of these implementations, the reconstruction neural network 116, the transcription neural network 118, or both can have a set of parameters of the pre-trained base generative neural network and a set of adapter parameters.

For example, the transcription neural network 118 can include a generative neural network and one or more generative adapter neural network layers. The generative neural network has parameters that have pre-trained values that are determined as a result of pre-training the generative neural network. The one or more generative adapter neural network layers each have respective adapter parameters that will be learned separately from, i.e., after, the pre-training of the generative neural network.

In some implementations, the one or more additional neural networks also include a multi-layer perceptron (a “pre-MLP”) that, when included, is arranged preceding to the vector quantizer 114 of the audio tokenizer 110.

The pre-MLP is configured to receive as input the set of embeddings generated by the encoder neural network 112 for the audio input, process the input to generate a set of pre-processed embeddings, and then provide the set of pre-processed embeddings as input to the vector quantizer 114.

Thus, in these implementations, during the training of the audio tokenizer 110, the vector quantizer 114 is configured to map each pre-processed embedding in the set of pre-processed embeddings to a corresponding audio token in the discrete set of audio tokens included in the codebook.

In some implementations, the one or more additional neural networks also include a multi-layer perceptron (a “post-MLP”) that, when included, is arranged subsequent to the vector quantizer 114 of the audio tokenizer 110.

The post-MLP is configured to receive as input the audio tokens generated by the vector quantizer 114, process the input to generate post-processed audio tokens, and then provide the post-processed audio tokens as input to a subsequent neural network for further processing.

Each MLP is a feed-forward neural network that includes multiple fully-connected layers. Optionally, one or more of the fully-connected layers can apply a non-linear activation function.

In some implementations, the one or more additional neural networks also include an adapter neural network 120 that, when included, is arranged subsequent to the vector quantizer 114 of the audio tokenizer 110 or the post-MLP (when included), and preceding to the reconstruction neural network 116 and the transcription neural network 118.

When included, the adapter neural network 120 is configured to process either the audio tokens generated by the vector quantizer 114 (when the post-MLP is not included) or the post-processed audio tokens generated by the post-MLP (when the post-MLP is included) to generate the representation of the audio input, and provide the representation of the audio input as input to both the reconstruction neural network 116 and the transcription neural network 118.

The adapter neural network 120 can have any of a variety of architectures that enable it to perform its functionality. For example, the adapter neural network 120 can have a Transformer architecture that includes one or more attention layers, a convolutional architecture that includes one or more convolutional layers, a feed-forward architecture that includes one or more feed-forward layers, and so on.

The use of these additional neural networks—including one or more of the pre-MLP, the post-MLP, and the adapter neural network—during the training of the audio tokenizer 110 introduces context-specific modulation, which improves the generalization and efficiency of the audio tokens generated by the audio tokenizer 110, and results in faster convergence of the audio tokenizer 110.

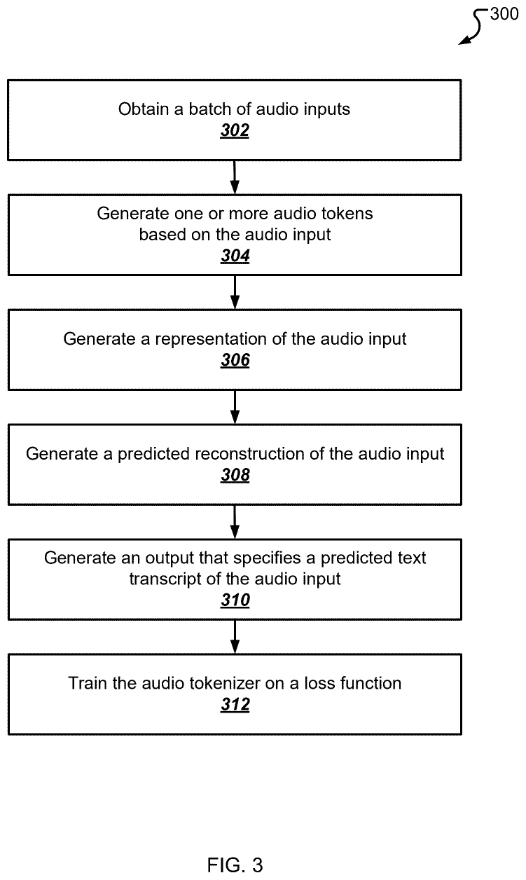

FIG. 3 is a flow diagram of an example process 300 for training an audio tokenizer. For convenience, the process 300 will be described as being performed by a system of one or more computers located in one or more locations. For example, a training system, e.g., the training system 100 depicted in FIG. 1, appropriately programmed in accordance with this specification, can perform the process 300.

The system can continue performing iterations of the process 300 until termination criteria for the training of the audio tokenizer have been satisfied, e.g., until the parameters have converged, until a threshold amount of wall clock time has elapsed, or until a threshold number of iterations of the process 300 have been performed.

The system obtains a batch of audio inputs from a training dataset (step 302). Each audio input represents a speech or another sound, e.g., a music or an environmental sound.

Each audio input can have any of a variety of formats. For example, the audio input can be represented as waveform data. As another example, the audio input can be represented as spectrogram data. As another example, the audio input can be represented as spectrum data.

The system will generally obtain different audio inputs at different iterations, e.g., by sampling a fixed number of audio inputs from a larger number of audio inputs stored in the training dataset at each iteration.

For each audio input in the batch, the system processes the audio input using the audio tokenizer to generate one or more audio tokens based on the audio input (step 304). In some implementations, the processing of the audio input makes use of the pre-MLP, the post-MLP, or both.

The audio tokenizer includes or is associated with a codebook that includes a discrete set of audio tokens. To tokenize the audio input into audio tokens, the audio tokenizer uses an encoder neural network to encode the audio input into a set of embeddings, and then uses a vector quantizer to map each embedding to a corresponding one of the audio tokens in the discrete set of audio tokens.

For each audio input in the batch, the system generates a representation of the audio input based on processing the one or more audio tokens generated by the audio tokenizer using one or more neural networks (step 306). In some implementations, the one or more neural networks include the adapter neural network.

For each audio input in the batch, the system processes the representation of the audio input using the reconstruction neural network to generate a predicted reconstruction of the audio input (step 308).

For each audio input in the batch, the system processes the representation of the audio input using the transcription neural network to generate an output that specifies a predicted text transcript of (an utterance in) the audio input (step 310).

The system trains the audio tokenizer to update the values of at least some of the parameters of the audio tokenizer based on optimizing a loss function (step 312).

For example, the system can update the values of the parameters of the encoder neural network. The system can do this by computing, for each audio input in the batch, respective gradients of the loss function with respect to the parameters of the audio tokenizer by backpropagation through the appropriate parameters of the audio tokenizer. The system can then determine the updates by applying an update rule, e.g., an Adam update rule, an Rmsprop update rule, or a stochastic gradient descent (SGD) update rule, to the respective gradients.

As another example, the system can update the audio tokens in the codebook based on the embeddings generated by the encoder neural network. The system can do this by applying an exponential moving average (EMA) update rule to update each audio token in the codebook to the exponential moving average of the embeddings generated by the encoder neural network that have been mapped to it over time.

The loss function includes a first term and a second term. The first term evaluates, for each audio input in the batch, a difference between (i) the predicted reconstruction of the audio input and (ii) the audio input.

In some implementations, the first term can be computed as any appropriate loss term, e.g., a distance-based loss term such as an L1 loss term or an L2 loss term, or a frequency-based loss term such as a short-time Fourier transform (STFT) loss term, that measures the difference between (i) the predicted reconstruction of the audio input and (ii) the audio input.

The second term evaluates, for each audio input in the batch, a difference between (i) the output that specifies the predicted text transcript and (ii) a ground truth output that specifies a ground truth text transcript of (the utterance in) the audio input.

In some implementations, the second term can be computed as any appropriate loss term, e.g., a maximum likelihood loss term, a cross-entropy loss term, or another text similarity-based loss term, that measures the difference between (i) the predicted text transcript and (ii) a ground truth text transcript of the audio input.

By optimizing the loss function that includes both the first and second terms, the system trains the audio tokenizer to generate audio tokens that encode richer semantic and acoustic information than audio tokens that would be generated by another audio tokenizer trained by a conventional training system without causing an excessively large increase in computation resource consumption during the training of the audio tokenizer because the system need not perform separate backward passes through the audio tokenizer to respectively update the trainable parameters of the audio tokenizer with respect to a reconstruction task and a transcript prediction task.

For example, the system can update the audio tokens in the codebook such that each audio token captures both acoustic features (learned through the term of the loss function) and semantic features (learned through the second term of the loss function) of the audio input using a comparable number of training iterations as the conventional training system.

In some implementations where the encoder neural network is initialized using a base encoder neural network that has already been pre-trained, the system trains the audio tokenizer beginning from the pre-trained values of the parameters of the encoder neural network in the audio tokenizer.

Analogously, in some implementations where the codebook is initialized using a learned codebook that has already been pre-trained, the system trains the audio tokens in the codebook beginning from the pre-trained audio tokens included in the predetermined codebook.

In some implementations, during the training of the audio tokenizer, the system trains the reconstruction neural network, the transcription neural network, or both jointly with the audio tokenizer.

In some of these implementations, during at least some of the iterations of the process 300, the system trains the reconstruction neural network jointly with the audio tokenizer on the first term of the loss function while holding values of the parameters of the encoder neural network in the audio tokenizer fixed.

In some of these implementations, during at least some of the iterations of the process 300, the system updates only a subset of the parameters of the transcription neural network. For example, the system can train the one or more generative adapter neural network layers jointly with the audio tokenizer on the second term of the loss function while holding the parameters of the generative neural network fixed to the pre-trained values.

In some implementations, as will be described below, the system trains different components of the audio tokenizer across multiple stages. During the first stage, the system trains the encoder neural network in the audio tokenizer. During the second stage, the system trains the encoder neural network jointly with the vector quantizer in the audio tokenizer.

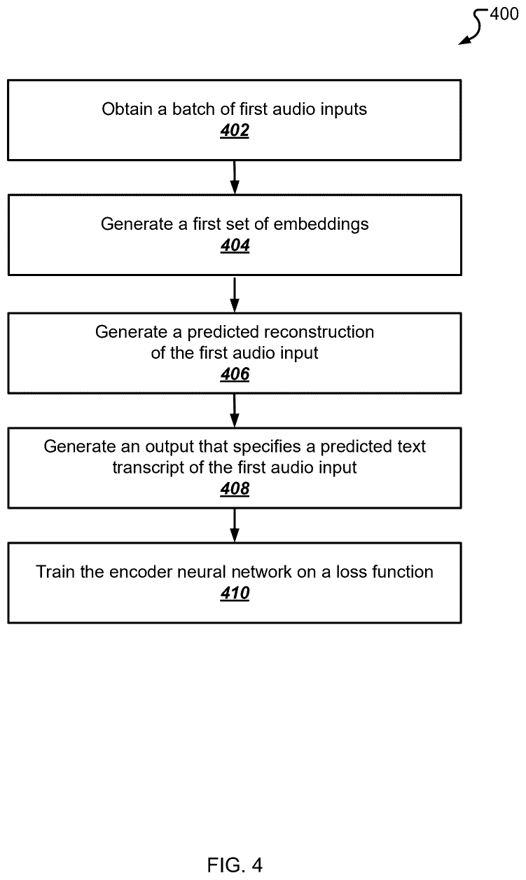

FIG. 4 is a flow diagram of another example process 400 for training the encoder neural network. For convenience, the process 400 will be described as being performed by a system of one or more computers located in one or more locations. For example, a training system, e.g., the training system 100 depicted in FIG. 1, appropriately programmed in accordance with this specification, can perform the process 400.

The system can continue performing iterations of the process 400 until termination criteria for the first stage training of the audio tokenizer have been satisfied, e.g., until the parameters have converged, until a threshold amount of wall clock time has elapsed, or until a threshold number of iterations of the process 400 have been performed.

The system obtains a batch of first audio inputs from the training dataset (step 402). Each first audio input represents a speech or another sound, e.g., a music or an environmental sound. Each first audio input can have any of a variety of formats.

For each first audio input in the batch, the system processes the first audio input using the encoder neural network to generate a first set of embeddings (step 404).

For each first audio input in the batch, the system processes the first set of embeddings using the reconstruction neural network to generate a predicted reconstruction of the first audio input (step 406).

For each first audio input in the batch, the system processes the first set of embeddings using the transcription neural network to generate an output that specifies a predicted text transcript of (an utterance in) the first audio input (step 408).

Thus, the processing of the audio input does not include processing the first sets of embeddings using the vector quantizer, the pre-MLP, the post-MLP, or the adapter neural network. That is, the reconstruction neural network and the transcription neural network directly receives the embeddings generated by the encoder neural network as input.

The system trains the encoder neural network to update the values of the parameters of the encoder neural network based on optimizing a loss function (step 410). The system can do this by computing, for each first audio input in the batch, respective gradients of the loss function with respect to the parameters of the audio tokenizer by backpropagation through the appropriate parameters of the audio tokenizer. The system can then determine the updates by applying an update rule, e.g., an Adam update rule, an Rmsprop update rule, or a stochastic gradient descent (SGD) update rule, to the respective gradients.

The loss function includes a first term and a second term. The first term evaluates, for each first audio input in the batch, a difference between (i) the predicted reconstruction of the first audio input and (ii) the first audio input. The second term evaluates, for each first audio input in the batch, a difference between (i) the output that specifies the predicted text transcript and (ii) a ground truth output that specifies a ground truth text transcript of (the utterance in) the first audio input.

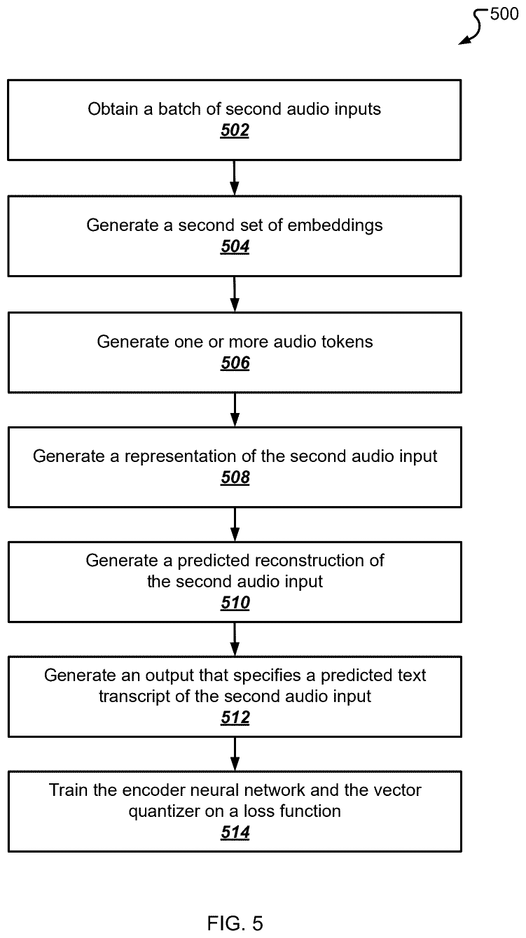

FIG. 5 is a flow diagram of another example process 500 for training the encoder neural network. For convenience, the process 500 will be described as being performed by a system of one or more computers located in one or more locations. For example, a training system, e.g., the training system 100 depicted in FIG. 1, appropriately programmed in accordance with this specification, can perform the process 500.

The system can begin to perform iterations of the process 500 after the termination criteria for the first stage training of the audio tokenizer have been satisfied, and continue performing iterations of the process 500 until termination criteria for the second stage training of the audio tokenizer have been satisfied, e.g., until the parameters have converged, until a threshold amount of wall clock time has elapsed, or until a threshold number of iterations of the process 500 have been performed.

The system obtains a batch of a second audio inputs from the training dataset (step 502). Each second audio input represents a speech or another sound, e.g., a music or an environmental sound. Each second audio input can have any of a variety of formats. The second audio inputs obtained by the system during the second stage training may differ from the first audio inputs obtained by the system during the first stage training.

For each second audio input in the batch, the system processes the second audio input using the encoder neural network to generate a second set of embeddings (step 504).

For each second audio input in the batch, the system processes the second set of embeddings using the vector quantizer to generate one or more audio tokens (step 506). In some implementations, the processing of the audio input makes use of the pre-MLP, the post-MLP, or both.

The one or more audio tokens are selected by the vector quantizer based on the second set of embeddings from the discrete set of audio tokens included in the codebook of the audio tokenizer.

For each second audio input in the batch, the system generates a representation of the second audio input based on processing the one or more audio tokens generated by the audio tokenizer using one or more neural networks (step 508). In some implementations, the one or more neural networks include the adapter neural network.

For each second audio input in the batch, the system processes the representation using the reconstruction neural network to generate an output that specifies a predicted reconstruction of the second audio input (step 510).

For each second audio input in the batch, the system processes the representation using the transcription neural network to generate a predicted text transcript of (an utterance in) the second audio input (step 512).

The system trains the encoder neural network and the vector quantizer to update the values of the parameters of the encoder neural network and the audio tokens in the codebook based on optimizing the loss function (step 514).

The system can update the values of the parameters of the encoder neural network by computing, for each second audio input in the batch, respective gradients of the loss function with respect to the parameters of the encoder neural network by backpropagation through the appropriate parameters of the audio tokenizer. The system can then determine the updates by applying an update rule, e.g., an Adam update rule, an Rmsprop update rule, or a stochastic gradient descent (SGD) update rule, to the respective gradients.

The system can update the audio tokens in the codebook by applying an exponential moving average (EMA) update rule to update each audio token in the codebook to the exponential moving average of the embeddings generated by the encoder neural network that have been mapped to it over time.

The loss function includes a first term and a second term. The first term evaluates, for each second audio input in the batch, a difference between (i) the predicted reconstruction of the second audio input and (ii) the second audio input. The second term evaluates, for each second audio input in the batch, a difference between (i) the output that specifies the predicted text transcript and (ii) a ground truth output that specifies a ground truth text transcript of (the utterance in) the second audio input.

By training different components of the audio tokenizer across multiple stages, the system achieves pre-alignment of the embedding space. The audio tokens in the codebook don't have to start from scratch; they can be initialized by clustering or sampling from the already-meaningful embeddings generated by the encoder neural network, thus improving the efficiency and quality of the subsequent joint training.

Moreover, training the encoder neural network first ensures that the embeddings capture the necessary information before they are forced to be discrete, i.e., mapped to corresponding audio tokens in the discrete set of audio tokens (codewords) included in the codebook. This avoids codebook collapse, where many codewords become unused, limiting the expressive power.

Thus, the multi-stage training results in savings in computation resources during the training of the audio tokenizer because fewer total training iterations are required to train the audio tokenizer to reach the desired level of accuracy in reconstruction and transcription prediction, and because the training stability is improved as codebook collapse may be avoided.

While the discussion in this specification focuses on audio data, it should be noted that the techniques described in this specification equally apply to other types of data, e.g., image data or video data. For example, the techniques can be used to train an image tokenizer to generate tokens based on images. Once trained, the image tokenizer can be used in image-based text processing applications, e.g., an optical character recognition application, for example.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. Computer elements may include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining an audio input;
processing the audio input using an audio tokenizer to generate one or more audio tokens based on the audio input;
generating a representation of the audio input based on the one or more audio tokens;
processing the representation using a reconstruction neural network to generate a predicted reconstruction of the audio input;
processing the representation using a transcription neural network to generate an output that specifies a predicted text transcript of the audio input; and
training the audio tokenizer on a loss function that includes a first term based on a difference between (i) the predicted reconstruction of the audio input and (ii) the audio input, and a second term based on a difference between (i) the output that specifies the predicted text transcript and (ii) a ground truth output that specifies a ground truth text transcript of the audio input.

2. The method of claim 1, wherein the one or more audio tokens are one or more discrete audio tokens that are each selected from a discrete set of audio tokens.

3. The method of claim 2, wherein the audio tokenizer comprises:
an encoder neural network that processes the audio input to generate a set of embeddings;
a learned codebook that comprises the discrete set of audio tokens; and
a vector quantizer configured to map each embedding to a corresponding audio token in the discrete set of audio tokens included in the learned codebook.

4. The method of claim 3, wherein training the audio tokenizer comprises:
updating the audio tokens in the learned codebook based on the set of embeddings.

5. The method of claim 3, wherein the encoder neural network comprises one or more convolution-augmented attention blocks.

6. The method of claim 1, wherein generating the representation of the audio input based on the one or more audio tokens comprises:
processing the one or more audio tokens generated by the audio tokenizer using one or more neural networks to generate the representation.

7. The method of claim 1, wherein the transcription neural network comprises:
a generative neural network that has parameters, the parameters having pre-trained values that are determined as a result of pre-training the generative neural network; and
one or more generative adapter neural network layers that each have respective adapter parameters.

8. The method of claim 7, further comprising:
training the one or more generative adapter neural network layers jointly with the audio tokenizer on the second term of the loss function while holding the parameters of the generative neural network fixed to the pre-trained values.

9. The method of claim 1, further comprising:
training the reconstruction neural network jointly with the audio tokenizer on the first term.

10. The method of claim 9, wherein training the reconstruction neural network jointly with the audio tokenizer comprises holding values of encoder parameters of the encoder neural network included in the audio tokenizer fixed.

11. The method of claim 1, wherein training the audio tokenizer comprises training the audio tokenizer beginning from pre-trained audio tokens included in a pre-determined codebook.

12. The method of claim 1, wherein the audio input comprises audio waveform data or audio spectrogram data.

13. A method performed by one or more computers, the method comprising:
training an encoder neural network on first audio inputs, wherein training the encoder neural network comprises:
obtaining a first audio input;
processing the first audio input using the encoder neural network to generate a first set of embeddings;
processing the first set of embeddings using a reconstruction neural network to generate a predicted reconstruction of the first audio input;
processing the first set of embeddings using a transcription neural network to generate an output that specifies a predicted text transcript of the first audio input;
training the encoder neural network on a loss function that includes a first term based on a difference between (i) a predicted reconstruction of the first audio input and (ii) the first audio input, and a second term based on a difference between (i) the output that specifies the predicted text transcript of the first audio input and (ii) a ground truth output that specifies a ground truth text transcript of the first audio input; and
after training the encoder neural network on the first audio inputs, training the encoder neural network jointly with a vector quantizer on second audio inputs, wherein training the encoder neural network jointly with the vector quantizer comprises:
obtaining a second audio input;
processing the second audio input using the encoder neural network to generate a second set of embeddings;
processing the second set of embeddings using the vector quantizer to generate one or more audio tokens selected from a discrete set of audio tokens included in a learned codebook associated with the vector quantizer;
generating a representation of the second audio input based on the one or more audio tokens;
processing the representation using the reconstruction neural network to generate an output that specifies a predicted reconstruction of the second audio input;
processing the representation using the transcription neural network to generate a predicted text transcript of the second audio input;
training the encoder neural network and the vector quantizer on the loss function that includes the first term based on a difference between (i) a predicted reconstruction of the second audio input and (ii) the second audio input, and the second term based on a difference between (i) the output that specifies the predicted text transcript of the second audio input and (ii) a ground truth output that specifies a ground truth text transcript of the second audio input.

14. A system comprising one or more computers and one or more storage devices storing instructions that when executed by the one or more computers cause the one or more computers to perform operations comprising:
obtaining an audio input;
processing the audio input using an audio tokenizer to generate one or more audio tokens based on the audio input;
generating a representation of the audio input based on the one or more audio tokens;
processing the representation using a reconstruction neural network to generate a predicted reconstruction of the audio input;
processing the representation using a transcription neural network to generate an output that specifies a predicted text transcript of the audio input; and
training the audio tokenizer on a loss function that includes a first term based on a difference between (i) the predicted reconstruction of the audio input and (ii) the audio input, and a second term based on a difference between (i) the output that specifies the predicted text transcript and (ii) a ground truth output that specifies a ground truth text transcript of the audio input.

15. The system of claim 14, wherein the one or more audio tokens are one or more discrete audio tokens that are each selected from a discrete set of audio tokens.

16. The system of claim 15, wherein the audio tokenizer comprises:
an encoder neural network that processes the audio input to generate a set of embeddings;
a learned codebook that comprises the discrete set of audio tokens; and
a vector quantizer configured to map each embedding to a corresponding audio token in the discrete set of audio tokens included in the learned codebook.

17. The system of claim 16, wherein training the audio tokenizer comprises:
updating the audio tokens in the learned codebook based on the set of embeddings.

18. The system of claim 17, wherein the encoder neural network comprises one or more convolution-augmented attention blocks.

19. The system of claim 14, wherein generating the representation of the audio input based on the one or more audio tokens comprises:
processing the one or more audio tokens generated by the audio tokenizer using one or more neural networks to generate the representation.

20. The system of claim 14, wherein the transcription neural network comprises:
a generative neural network that has parameters, the parameters having pre-trained values that are determined as a result of pre-training the generative neural network; and
one or more generative adapter neural network layers that each have respective adapter parameters.
